(19) United States
(12) Patent Application Publication
(10) Pub. No.: US 2006/0133097 A1
(43) Pub. Date: Jun. 22, 2006

(54) Movable light mount

(76) Inventors: Anthony J. Doric, Waller, TX (US); Paul Fenley, Sugarland, TX (US)

Correspondence Address: MEYERTONS, HOOD, KIVLIN, KOWERT & GOETZEL, P.C., 700 LAVACA, SUITE 800, AUSTIN, TX, 78701, US

(21) Appl. No.: 11/019,093

(22) Filed: Dec. 21, 2004

(51) Int. Cl. F21V 21/20

(52) U.S. Cl. 362/401

(57) ABSTRACT

An apparatus for mounting a light fixture in a freight loading/unloading area is described. The apparatus may include a mounting member. A restoring device may be coupled to the mounting member. A movable member may be coupled to the mounting member. The movable member may rotate about an axis of the mounting member. The movable member may be coupled to a light fixture. The movable member may be positioned in a set position about the axis of the mounting member to allow the light fixture to illuminate a freight loading/unloading area. The restoring device may provide a restoring force to return the movable member to approximately the set position if the movable member is moved from the set position.

### BACKGROUND

1. Field of the Invention

The present invention generally relates to light systems for freight loading/unloading areas. Certain embodiments relate to apparatus for mounting and supporting a light fixture in a freight loading/unloading area.

2. Description of Related Art

Light fixtures are used in loading docks to illuminate a freight loading/unloading area. For example, light fixtures may be used to illuminate the insides of truck trailers, storage containers, or other types of vessels used at a freight loading/unloading area (e.g., a loading dock). Loading and unloading of freight is usually done by manual labor or using a fork lift or crane. The truck trailer is typically enclosed, except for the rear end or another access door, and has no internal lighting. Thus, ambient light from the loading dock is generally insufficient to light the interior of a truck trailer, especially for relatively long truck trailers. Light fixtures attached to the loading dock that focus light into the interior of the truck trailer are used to solve this problem. For example, a light fixture can be used to illuminate the inside of a truck trailer parked at a loading dock of a building, store, warehouse, freight terminal, or other similar facility. The loading and unloading of freight may take more time without a light fixture illuminating the inside of a truck trailer. This increased time may reduce productivity and increase operating costs. Providing light in the freight loading/unloading area may increase productivity by as much as about 33 percent. Also, loading and unloading freight in non-lit areas increases the risk of injuries to workers, freight, and/or equipment.

Current light fixtures used in loading docks employ incandescent or high-intensity discharge (HID) light sources enclosed in steel or composite housings. The lighting fixture may be mounted on a swing arm or attached directly to a doorframe on the loading dock. A lighting fixture mounted or placed in the doorway of a loading dock may be subject to forces from being hit by workers, or impacted by equipment such as fork lifts, cranes, cargo, freight, or trucks. The filaments or electrodes may break or fail after the light fixture is subjected to an impact force. Because this is a common occurrence, the light source, or the entire light fixture, may have to be replaced relatively frequently. This can be a time consuming and cumbersome task. Also, housings of these light fixtures can be damaged under numerous impacts encountered by the light fixture. These housings, or entire light fixtures, may have to be replaced, on average, up to about once every 18 months. At some loading docks, light fixtures are frequently not repaired and, hence, freight is loaded or unloaded in the dark, which decreases productivity and increases the risk of injury and/or damage to freight.

Some current light fixtures are mounted on adjustable mounting arms (e.g., swing arms). An adjustable mounting arm may be mounted on or adjacent a freight loading/unloading area door (e.g., a loading dock door). For example, an adjustable mounting arm may be mounted on or adjacent to a loading dock door jam. Typical adjustable mounting arms are lightweight articulated mounting arms that may be manually adjusted and readjusted as needed. An adjustable mounting arm may be manually readjusted to a proper position after the arm has been misaligned due to, for example, a collision with a forklift or other object. In some cases, a mounting arm (e.g., a lightweight mounting arm) may be damaged by a collision with a forklift or other object. Misalignment and/or damage of adjustable mounting arm light fixtures may be common occurrence in high traffic areas such as a freight loading/unloading area.

U.S. Pat. No. 5,357,414 to Dane et al., which is incorporated by reference as if fully set forth herein, describes a light fixture with a tubular support arm having a cantilevered end and a mounting end with an electric light head secured at the cantilevered end and a mounting bracket at the mounted end. The light fixture has a readily releasable electrical connection between the arm and the head. The light head has a shell, a socket for receiving a lamp bulb, and bracketry for mounting the socket to the shell to bias a bulb held in the socket against the shell.

U.S. Pat. No. 5,709,458 to Metz, which is incorporated by reference as if fully set forth herein, describes a dock light where the lamp assembly is mounted on a hollow flexible tube. The tube is connected to a base member, which is secured to a support structure. The lamp assembly may be angled in any desired direction relative to the base member. The base member may also be provided with a fan. The fan may force cooling air through the hollow flexible tube to cool the light bulb.

U.S. Pat. No. 4,973,016 to Hertenstein, which is incorporated by reference as if fully set forth herein, describes a multi-arm arrangement including a pair of inner arms and an outer arm. The inner end of the outer arm is pivotally connected between the outer ends of the two inner arms. Fan and light support members are pivotally mounted at the outer end of the outer arm. A fan is pivotally mounted to the fan support member and a light is pivotally mounted to the light support member.

### SUMMARY

In an embodiment, an apparatus for mounting a light fixture in a freight loading/unloading area may include a mounting member. The mounting member may be coupled to a support structure in the freight loading/unloading area. A restoring device may be coupled to the mounting member. In certain embodiments, a restoring device includes a reciprocating member (e.g., a door closer such as a spring, wire form door closer) pivotally coupled to the mounting member and a cam device coupled to the reciprocating member and the mounting member. A movable member may be coupled to the mounting member. The movable member may rotate about an axis of the mounting member. In certain embodiments, a movable member may rotate 360° and in either direction about an axis of a mounting member. The movable member may be positioned in a set position about the axis of the mounting member. The restoring device may provide a restoring force to return the movable member to approximately the set position if the movable member is moved from the set position. A movable member may be moved from the set position when a force is applied to the movable member. The movable member may be coupled to a light fixture. A light fixture may be coupled to the movable member. The light fixture may illuminate a freight loading/unloading area when the movable member is in a set position.

### BRIEF DESCRIPTION OF THE DRAWINGS

Advantages of the present invention may become apparent to those skilled in the art with the benefit of the following detailed description and upon reference to the accompanying drawings in which:

FIG. 1 depicts a perspective view of an embodiment of a light fixture mounting apparatus.

FIGS. 2A and 2B depict cross-sectional representations of an embodiment of a light fixture mounting apparatus from a side view (FIG. 2A) and an end view (FIG. 2B).

FIG. 3 illustrates a cross-sectional view of an embodiment of a light fixture that may be used to illuminate a freight loading/unloading area.

FIG. 4 depicts an embodiment of a light fixture as viewed from a front end.

FIG. 5 depicts an embodiment of a light fixture as viewed from a rear end.

FIG. 6 depicts an embodiment of a light fixture mounting apparatus mounted at a freight loading/unloading area from an end view of the freight loading/unloading area.

FIG. 7 depicts an embodiment of a light fixture mounting apparatus mounted at a freight loading/unloading area from a side view of the freight loading/unloading area.

FIG. 8 depicts a top view of an embodiment of a light fixture mounting apparatus with a movable member and a light fixture placed in a set position about an axis of a mounting member.

FIG. 9 depicts a top view of an embodiment of a light fixture mounting apparatus with a movable member and a light fixture rotated from a set position about an axis of a mounting member.

While the invention is susceptible to various modifications and alternative forms, specific embodiments thereof are shown by way of example in the drawings and may herein be described in detail. The drawings may not be to scale. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims.

### DETAILED DESCRIPTION

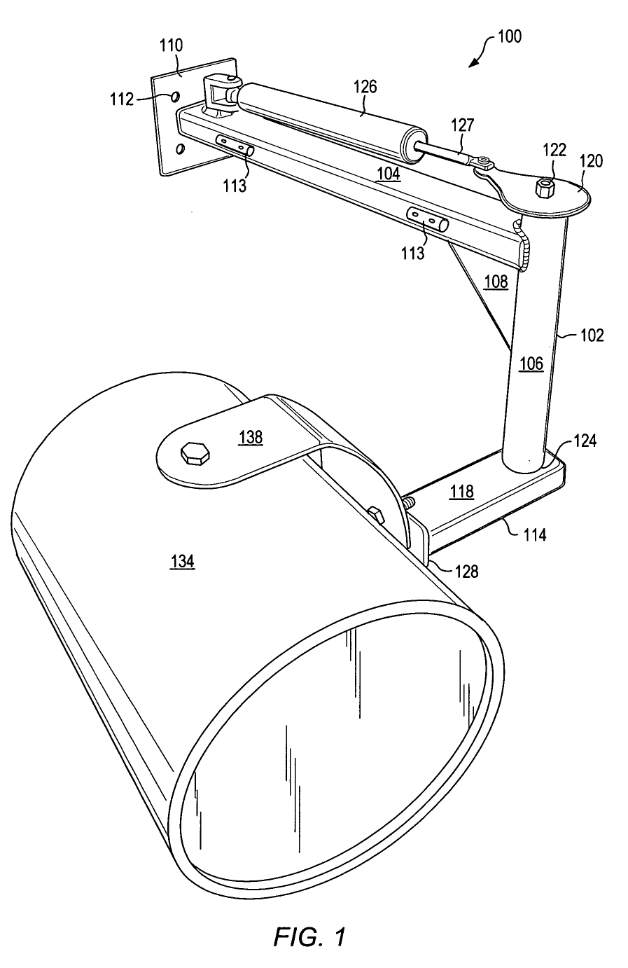

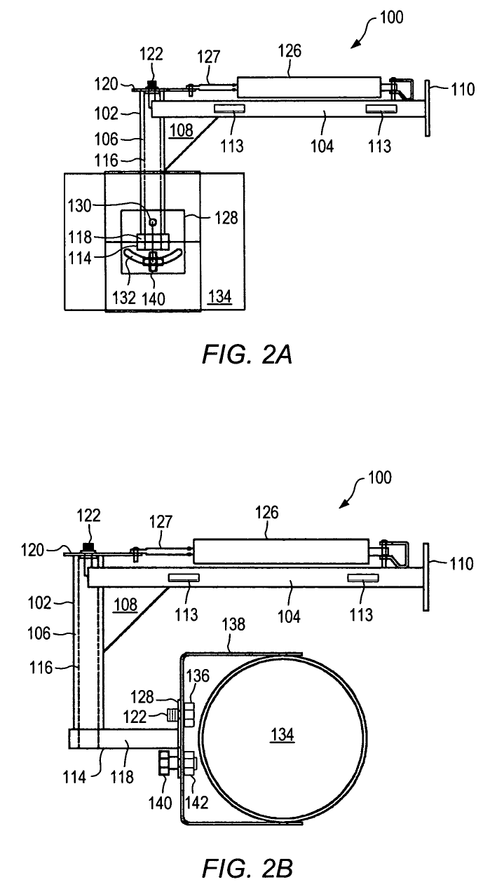

FIG. 1 depicts a perspective view of an embodiment of a light fixture mounting apparatus. FIGS. 2A and 2B depict cross-sectional representations of an embodiment of a light fixture mounting apparatus from a side view (FIG. 2A) and an end view (FIG. 2B). Apparatus 100 may include mounting member 102. Mounting member 102 may be made of structurally strong materials. In an embodiment, mounting member 102 is made of steel. Mounting member 102 may include one or more portions. Portions of mounting member 102 may be coupled together by, for example, welding or other suitable means for forming a structurally strong coupling between the portions. In an embodiment, as shown in FIGS. 1, 2A, and 2B, mounting member 102 may include first portion 104 and second portion 106. First portion 104 may be aligned at an angle to second portion 106. In certain embodiments, first portion 104 may be aligned at a substantially perpendicular angle to second portion 106. In some embodiments, first portion 104 may be aligned at an angle between about 70° and about 110° to second portion 106. In certain embodiments, support member 108 may be coupled (e.g., welded) to mounting member 102 at a junction between first portion 104 and second portion 106. Support member 108 may provide structural support for the junction between first portion 104 and second portion 106.

Mounting member 102 may include mounting plate 110. Mounting plate 110 may be coupled (e.g., welded) to first portion 104 of mounting member 102. Mounting plate 110 may be used to couple apparatus 100 to a support structure (e.g., a wall, a frame, or a support beam). Mounting plate 110 may include one or more holes 112. In an embodiment, mounting plate 110 includes four holes 112. Holes 112 may be used to couple mounting plate 110 to a support structure. For example, holes 112 may be used as washers for bolts or other fasteners to be placed through the holes and coupled to a support structure to affix apparatus 100 to the support structure.

One or more wiring couplers 113 may be coupled to mounting member 102 (e.g., first portion 104 of the mounting member). Wiring couplers 113 may be coupled to any side (e.g., a left side or a right side) of mounting member 102 or coupled to more than one side (e.g., a left side and a right side) of the mounting member. Wiring couplers 113 may be used for coupling wires from a light fixture to mounting member 102. In certain embodiments, wires may be threaded through wiring couplers 113 to inhibit the wires from hanging loosely and/or being caught or snagged by objects in a freight loading/unloading area. Wiring couplers 113 may allow wires to be placed through the wiring couplers loosely so that as a light fixture moves the wires may move back and forth within the wiring couplers. In certain embodiments, wiring couplers 113 may be cylindrical housings coupled to mounting member 102. Wiring couplers 113 may be coupled to mounting member 102 using, for example, screws or bolts.

As shown in FIGS. 1, 2A, and 2B, apparatus 100 may include movable member 114. Movable member 114 may be made of structurally strong materials. In an embodiment, movable member 114 is made of steel. In certain embodiments, movable member 114 may include insert portion 116 and swing portion 118, as shown in FIGS. 2A and 2B. Insert portion 116 and swing portion 116 may be solid pieces. Insert portion 116 may be coupled (e.g., welded) to swing portion 118 to for movable member 114. For example, insert portion 116 may extend into a hole in swing portion 118 and be welded into place. In some embodiments, insert portion 116 and swing portion 118 may be a unitary piece forming movable member 114. Insert portion 116 may be oriented at approximately a right angle relative to swing portion 118.

In certain embodiments, insert portion 116 may be inserted inside second portion 106 of mounting member 102, as shown in FIGS. 2A and 2B. Second portion 106 may include a longitudinal hollow cylinder that allows insert portion 116 to freely rotate within the hollow cylinder while inhibiting loose motion (e.g., side-to-side movement or jiggling) of the insert portion within the hollow cylinder. Thus, movable member 114 may rotate about a longitudinal axis of second portion 106. Insert portion 116 may be coupled to cam plate 120 using bolt 122 and one or more washers (e.g., lock washers or disc washers). Insert portion 116 may include threading for receiving bolt 122. In some embodiments, other fastening methods may be used to couple insert portion 116 to cam plate 120. For example, insert portion 116 may include a portion that extends through an opening in cam plate 120 and a nut or other fastener may be used to secure the cam plate to the extended portion of insert portion 116.

Insert portion 116 may extend from swing portion 118 a length that is slightly longer than a length of second portion 106 of mounting member 102 so that a surface of the insert portion extends slightly beyond a surface of the second portion at cam plate 120. Thus, cam plate 120 may rotate in conjunction with insert portion 116. One or more washers may be used at junction 124 of insert portion 116 and swing portion 118 to adjust an amount that insert portion 116 extends beyond second portion 106.

Cam plate 120 may couple to insert portion 116 of movable member 114 such that the movable member is coupled to second portion 106 of mounting member 102. Movable member 114 may be coupled to second portion 106 of mounting member 102 so that the movable member may rotate about a longitudinal axis of the second portion of the mounting member. In certain embodiments, movable member 114 may rotate 360° about a longitudinal axis of second portion 106 of mounting member 102. For example, movable member 114 may rotate up to about 360° about a longitudinal axis of second portion 106 of mounting member 102 prior to installation of apparatus 100. In certain embodiments, after installation of apparatus 100, movable member 114 may rotate up to about 180° about a longitudinal axis of second portion 106 of mounting member 102 (e.g., the movable member may rotate up to about 90° in either direction from a set position of the movable member). First portion 104 of mounting member 102 may have a length sufficient enough to allow movable member 114 and a light fixture coupled to the movable member to rotate 360° about a longitudinal axis of second portion 106. In certain embodiments, movable member 114 may rotate in either direction about a longitudinal axis of second portion 106 of mounting member 102. Allowing movable member 114 to rotate in either direction and 360° about a longitudinal axis of second portion 106 may allow the movable member and a light fixture coupled to the movable member to move regardless of which side of the light fixture or movable member is impacted by an object.

Cam plate 120 may be coupled to reciprocating member 126. Reciprocating member 126 may be a member that applies, or returns, a force (e.g., a restoring force) in a direction opposite to the direction of a force applied to the member. The restoring force applied, or returned, by reciprocating member 126 may be substantially equal to the force applied to the reciprocating member. In an embodiment, reciprocating member 126 may be a door closer (e.g., a screen or storm door closer). Such door closers (e.g., gas filled door closers, pneumatic door closers, or hydraulic door closers) may be obtained from Stanley Works (New Britain, Conn.), Wright Products Corp. (Rice Lake, Wis.) (e.g., Wright Products closer V2105), or McMaster-Carr (Chicago, Ill.). Reciprocating member 126 may be coupled to first portion 104 of mounting member 102. In embodiment, a first end of reciprocating member 126 is pivotally coupled to cam plate 120 and a second end of the reciprocating member is pivotally coupled to first portion 104 of mounting member 102. In an embodiment, a first end of reciprocating member 126 may be arm 127 of reciprocating member (e.g., arm 127 may be an arm of a door closer). The ends of reciprocating member 126 may be coupled to cam plate 120 and first portion 104 using any types coupling that allow for pivoting between the coupled pieces. For example, the ends of reciprocating member 126 may be coupled to cam plate 120 and first portion 104 using a ball and socket joint, a pin and bushing, or one or more clips. In certain embodiments, the ends of reciprocating member 126, which is a commercially obtained door closer, may be coupled to cam plate 120 and first portion 104 using types of couplings obtained as part of the door closer or modifications of the couplings obtained as part of the door closer.

In certain embodiments, reciprocating member 126 may provide a restoring force to movable member 114 through cam plate 120 so that the movable member is restored or returned to a set position if the movable member moves away from the set position. A set position of movable member 114 may be a set angular position about a longitudinal axis of second portion 106. A set position may be, for example, an angular position of movable member 114 about the longitudinal axis of second portion 106 in which a light fixture coupled to the movable member directs light in a desired direction. A set position of movable member 114 may be determined by a user of apparatus 100. In an embodiment, movable member 114 may be affixed in a set position by rotating the movable member to a desired angular position about a longitudinal axis of second portion 106 and tightening bolt 122. Thus, if movable member 114 moves (e.g., rotates) or is moved (e.g., moved by an applied force) away from the set position, reciprocating member 126 provides a restoring force to the movable member through cam plate 120 that moves (e.g., rotates) the movable member back to the set position (i.e., the reciprocating member operates through the cam plate to move (“close”) the movable member back to the set position (a “closed” position) as if the movable member operated as a door that had been moved to an “open position”).

In certain embodiments, reciprocating member 126 may be a door closer selected to provide a desired duty of restoring force. For example, reciprocating member 126 may be a light duty door closer, a medium duty door closer, or a heavy duty door closer. A designer or user of apparatus 100 may select a proper duty door closer based on, for example, a weight of a light fixture coupled to movable member 114.

Bracket 128 may be coupled to movable member 114. In certain embodiments, bracket 128 may be welded to movable member 114 to provide structural strength for the bracket. As shown in FIG. 2A, bracket 128 may include opening 130 and opening 132. Bracket 128 may be used to couple light fixture 134 to movable member 114. Coupling light fixture 134 to an end of movable member 114 distal from insert portion 116 may allow the light fixture to be offset from mounting member 102. For example, light fixture 134 may be offset from second portion 106 of mounting member 102 a distance approximately equal to a length of movable member 114. Offsetting light fixture 134 from mounting member 102 may allow the light fixture to better direct light at a freight loading/unloading area (e.g., light may be better directed into a truck trailer located at a freight loading/unloading area). In certain embodiments, second portion 106 may have a length sufficient to allow movable member 114 and light fixture 134 to rotate 360° about a longitudinal axis of the second portion without the rotation being inhibited by first portion 104 or any other portion of mounting member 102. A length of second portion 106 may be selected to locate a plane of light fixture 134 a desired distance lower than a plane of first portion 104 so that light may be easily directed to a freight loading/unloading area and a possibility of impacting first portion 104 with an object (e.g., a forklift or freight on a forklift) is reduced. A length of first portion 104 may be selected so that the rotation of light fixture 134 is not inhibited by a support structure, a portion of mounting member 102, or any other object coupled to the mounting member.

Opening 130 may allow for a fastener (e.g., a bolt) to couple light fixture 134 to bracket 128. For example, as shown in FIG. 2B, bolt 122 and nut 136 may be used to couple bracket 128 to bracket 138 of light fixture 134. As shown in FIG. 2A, opening 130 may be washer-type opening (e.g., substantially circular opening) used to affix a position of a fastener (e.g., bolt 122) on bracket 128. Opening 132 may have a substantially semicircular groove opening that allows a fastener (e.g., a bolt) to move within the opening. For example, as shown in FIG. 2B, bolt 140 and nut 142 may be used to couple bracket 128 to bracket 138 of light fixture 134. In some embodiments, bracket 138 may include a threaded opening for coupling to bolt 140. Bolt 140 may be a hand tightened bolt so that a user of apparatus 100 may easily tighten and loosen the bolt.

Using both opening 130 and opening 132 to couple bracket 128 to light fixture 134 may allow setting of a vertical alignment (e.g., a tilt) position of the light fixture relative to movable member 114. For example, light fixture 134 may be tilted upwards or downwards relative to a plane (e.g., a longitudinal axis plane) of movable member 114. Light fixture 134 may be rotated about an axis of a fastener located in opening 130 while the tilt angle of the light fixture is determined by a position of a fastener in opening 132. In certain embodiments, a shape of opening 132 may limit the range of tilt angle allowed for light fixture 134. Tightening of the fasteners (e.g., bolts 122 and 140) in opening 130 and opening 132 may set a vertical alignment (e.g., a tilt) position of light fixture 134. Thus, a user of apparatus 100 may be allowed to set a vertical alignment (e.g., tilt) position of light fixture 134 as desired.

In certain embodiments, the combination of setting an angular position of movable member 114 about a longitudinal axis of second portion 106 and setting a vertical alignment position of light fixture 134 relative to the movable member may allow for controlled positioning of the light fixture in both vertical and horizontal directions. Setting the angular position of movable member 114 about a longitudinal axis of second portion 106 allows for controlled positioning of light fixture 134 in a horizontal direction. Setting the vertical alignment position of light fixture 134 relative to the movable member allows for controlled positioning of the light fixture in a vertical direction. Thus, a user of apparatus 100 may controllably direct light in a freight loading/unloading area as desired.

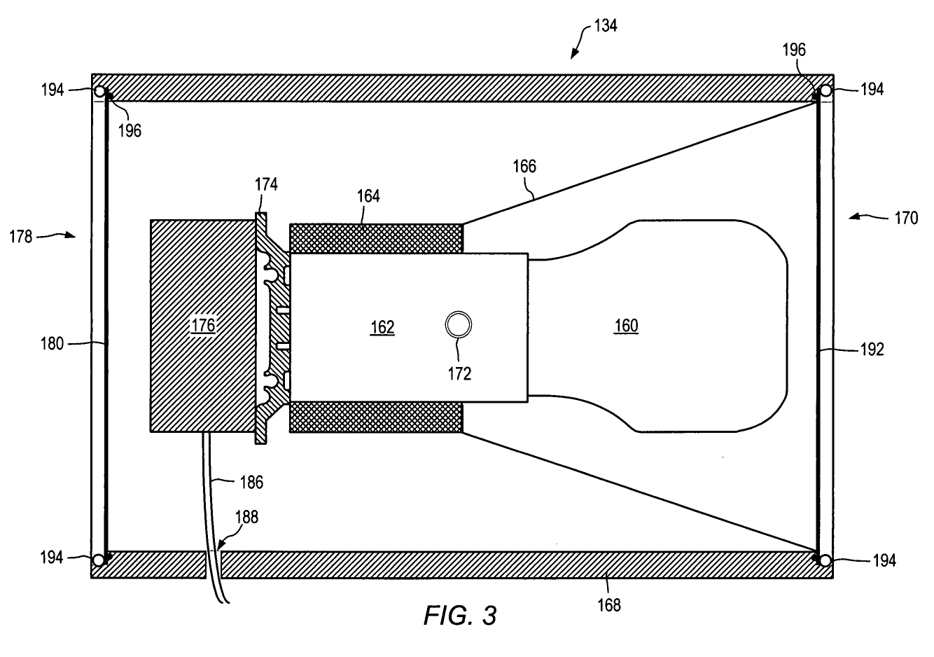

FIG. 3 illustrates a cross-sectional view of an embodiment of light fixture 134 that may be used to illuminate a freight loading/unloading area. Light source 160 may be coupled to socket 162. Socket 162 may be included as a component of light source 160. Light source 160 may be a light without a filament and/or an electrode to produce illumination. A filament or electrode light source may have a relatively short lifetime due to burn out and/or damage to the filament or electrode caused by impact forces subjected to a light fixture in a freight loading/unloading area. In an embodiment, light source 160 may be an electrode-less light source that uses an antenna to generate a glow discharge within the light source. For example, light source 160 may be an induction light source such as a 55 W QL light source obtained from Philips Lighting Corporation (the Netherlands). The 55 W QL light source has a length of about 5.5 inches (including socket) with a maximum diameter of about 3.35 inches. In some embodiments, an induction light source with higher or lower wattage ratings may be used (e.g., an 85 W QL light source from Philips Lighting Corporation). An induction light source may generate about 80 lumens/watt of light with a lifetime of up to about 100,000 hours. A 55 W induction light source may generate about 4400 lumens of illumination.

Using a relatively low wattage induction light source may reduce utility costs associated with a light fixture. Also, a low wattage light source may have a lower operating temperature than other light sources. Thus, less cooling may be required for a low wattage induction light source. The relatively long lifetime of an induction light source may contribute to a relatively low maintenance light fixture. A standard incandescent light bulb may generate about 15 lumens/watt with a lifetime of less than about 700 hours. A high-intensity discharge (HID) light source may generate about 80 lumens/watt. The electrode used in a HID light source, however, may be fragile and prone to failure in a harsh work environment such as a freight loading/unloading area.

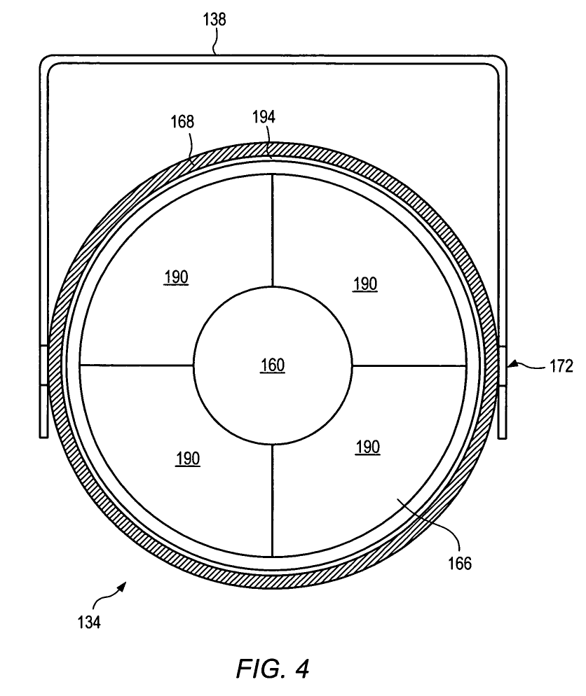

Socket 162 of light source 160 may be coupled to reflector mount 164. Reflector mount 164 may be coupled to reflector 166. Light source 160 may be supported by reflector 166, which is coupled to housing 168. FIG. 4 depicts an embodiment of light fixture 134 as viewed from front end 170, referenced in FIG. 3. As shown in FIG. 4, light fixture 134 may be coupled to bracket 138 at point 172. In certain embodiments, bracket 138 may be affixed to light fixture 134 at point 172. In some embodiments, bracket 138 may allow light fixture 134 to rotate about point 172 such that light source 160 may be positioned in a desired direction. In certain embodiments, bracket 138 may be a fixed bracket or any similar mounting device that supports light fixture 134. In some embodiments, bracket 138 may be a trunnion mount, yoke arm, swivel arm, or any mounting device that supports light fixture 134 and allows for movement of the light fixture. Bracket 138 may support light fixture 134 such that light source 160 is isolated from impact forces subjected to the light fixture during use. The coupling between bracket 138 and light fixture 134 may break and/or fail before any damage is sustained by light source 160 when subjected to impact forces. Bracket 138 may also allow light fixture 134 to swing freely and/or be oriented with more than one degree of freedom. For example, a ball and socket joint can be used at point 172 to allow light fixture 134 to be oriented in several possible directions

As shown in FIG. 3, socket 162 of light source 160 may be coupled to cross brace 174. Socket 162 may be coupled to cross brace 174 with any fasteners known in the art (e.g., screws, bolts, nails, clamps). For example, socket 162 may be coupled to cross brace 174 using screws. Cross brace 174 may be operable as a heat sink to remove heat from socket 162. Cross brace 174 may include materials that substantially conduct heat away from light source 160, socket 162, and/or generator 176. For example, cross brace 174 may include extruded aluminum. Cross brace 174 may have a shape that enhances its heat dissipation properties (e.g., a relatively large surface area exposed to air). Cross brace 174 may have a large air-exposed surface area compared to a surface area in contact with other components in light fixture 134. Cross brace 174 may be coupled to housing 168. In certain embodiments, cross brace 174 may be bolted to housing 168. Cross brace 174 may provide support to light source 160. In some embodiments, generator 176 may be mounted to cross brace 174. Cross brace 174 may be coupled to reflector mount 164. Cross brace 174 may provide support for reflector mount 164 and reflector 166.

Generator 176 may include components used to control electrical output to light source 160. Generator 176 may be, for example, a high frequency (HF) ballast generator manufactured by Philips Lighting Corporation or any power source suitable for use with induction light sources. Dimensions of cross brace 174 may be compatible to those of generator 176. In an embodiment, generator 176 has a height of about 1.6 inches, a width of about 4 inches, and a length of about 5.5 inches.

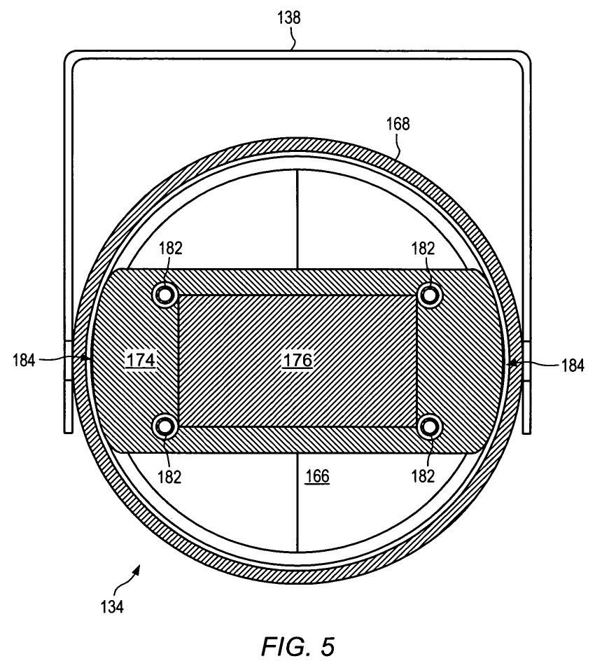

FIG. 5 depicts an embodiment of light fixture 134 as viewed from rear end 178, referenced in FIG. 3 with end cap 180 removed. A shape of cross brace 174 may vary depending on, for example, a shape of housing 168, a size of generator 176, and/or a desired use of the cross brace. Cross brace 174 may be a brace having a width slightly greater than the width of generator 176. In an embodiment, cross brace 174 has a width of greater than about 4 inches. Generator 176 may be coupled to cross brace 174 using fasteners 182. Fasteners 182 may be any fasteners known in the art (e.g., bolts or screws). In an embodiment, fasteners 182 are screws. Cross brace 174 may be coupled to housing 168 proximate points 184. Cross brace 174 may be coupled to housing 168 using fasteners known in the art. In an embodiment, cross brace 174 may be coupled to housing 168 using bolts. Cross brace 174 may support generator 176. Cross brace 174 may inhibit movement of generator 176, light source 160, and/or reflector 166 within housing 168.

Electrical power for generator 176 may be provided from an external power source through wiring 186, shown in FIG. 3. The external power source may provide alternating current (AC) power to generator 176. For example, the external power source may be a 120 volts AC (VAC), 60 hertz (Hz) electric outlet. Other voltages and/or frequencies may be used as required by specifications for generator 176. Electrical power may be provided to light source 160 from generator 176 using any method known in the art. In some embodiments, electrical power may be provided to light source 160 through a wire and a power coupler supplied by a manufacturer of light source 160 and generator 176. In an embodiment, a power coupler may be an antenna configured to generate a glow discharge within light source 160.

As shown in FIG. 3, wiring 186 may enter light fixture 134 through hole 188 formed in housing 168. In some embodiments, wiring 186 may enter light fixture 134 through a hole formed in end cap 180. Space of hole 188 around wiring 186 may be sealed with, for example, an o-ring or a bonding compound. Wiring 186 may also be coupled to bracket 138 and any support member coupled to the bracket (e.g., apparatus 100 depicted in FIGS. 1-2B). Coupling wiring 186 to a support member may inhibit the wiring from being damaged and/or broken during use. Wiring 186 may be any wire generally available in the art that may be rated to carry the current and voltage required by generator 176. In an embodiment, wiring 186 is insulated, dual copper conductor cable rated for at least 1 amp at 120 VAC.

As shown in FIG. 4, reflector 166 may include more than one reflector. In certain embodiments, reflector 166 may include four individual reflectors 190. Reflectors 190 may include reflective materials such as aluminum or aluminum alloys. For example, reflectors 190 may include a reflective metallic material such as that provided by Alanod (Germany). Reflectors 190 may be coupled together such that they form a single continuous reflector or a substantially round circumference reflector. Reflectors 190 may each include about one-quarter of reflector 166. Reflector 166 may be a specular reflector configured to focus light from light source 160 into a freight loading/unloading area. Dimensions of reflector 166 (e.g., angle of reflection, circumference, spacing from light source 160, or length) may be modified such that reflector 166 focuses a maximum amount of light available from the light source into a freight loading/unloading area. In some embodiments, reflector 166 may be up to about 95% efficient in reflecting light into the freight loading area (i.e., about 95% of the light generated by light source 160 is focused into the freight loading area). Reflecting a maximum amount of light may substantially increase illumination of a freight loading/unloading area. Reflector 166 may also reduce glare encountered by an operator in a freight loading/unloading area. For example, reflector 166 may reduce glare when the operator is backing equipment out of a freight loading/unloading area. Reducing glare may decrease the possibility of collisions causing damage and/or injury in a freight loading/unloading area.

Reflector 166 may be coupled to reflector mount 164, as shown in FIG. 3. An end of reflector 166 coupled to reflector mount 164 may have a flat surface corresponding to the surface of the reflector mount. Reflector 166 may be coupled to reflector mount 164 using any fastener known in the art. For example, reflector 166 may be coupled to reflector mount 164 using rivets, bolts, screws, and/or welding. In an embodiment, reflector 166 is coupled to reflector mount 164 using screws. Reflector 166 may be coupled to housing 168 using lens 192 and retainment device 194 to fasten the reflector to the housing. O-ring 196 may be placed between reflector 166 and housing 168.

As shown in FIG. 3, light source 160, socket 162, generator 176, cross brace 174, reflector mount 164, and reflector 166 may be placed in housing 168. Housing 168 may be a conduit or any similar tubular enclosure. Housing 168 may include polymeric materials, such as polyvinyl chloride (PVC) or aluminum, that are strong, lightweight, corrosion resistant, and relatively inexpensive. Using such materials for housing 168 may increase the ability of the housing to withstand the numerous impacts encountered in a freight loading/unloading area without damaging the housing and/or components within the housing (e.g., light source 160). This may significantly increase an operational lifetime of light fixture 134 in a freight loading/unloading area. In an embodiment, housing 168 may be a schedule 80 PVC pipe with a wall thickness of about 0.5 inches and an outside diameter of about 8.6 inches. Housing 168 may be formed by selecting a desired length of material. Forming housing 168 may include cutting or trimming a longer section of material into a shorter, desired length of material. The desired length may be, for example, about 10 inches. However, the desired length of housing 168 may vary depending on, for example, a selected application for using light fixture 134, a size of generator 176, and/or a size of light source 160.

Notches may be formed in each end of housing 168 to allow placement of either lens 192 or end cap 180. The notches may be formed by machining each of the ends of housing 168 to a sufficient radius such that either lens 192 or end cap 180 may be relatively tightly held within the housing. Retainment devices 194 may be placed in the notch to secure lens 192 and end cap 180 into housing 168. O-rings 196 may be placed between lens 192 or end cap 180 and housing 168. Shock absorbing properties of o-rings 196 may inhibit damage to lens 192 or end cap 180. O-rings 196 may also inhibit water and/or other contaminants from entering housing 168. Retainment device 194 may be any device that may secure end cap 180 or lens 192 to housing 168. Retainment device 194 may be, for example, a ring such as a stainless steel ring or spring steel ring.

Lens 192 may include any substantially transparent material that allows a significant portion of light from light source 160 to pass through and illuminate a freight loading/unloading area. For example, lens 192 may be made of acrylic. An acrylic lens may inhibit the lens from breaking due to impact forces imparted to light fixture 134. In an embodiment, the lens may be made of a polyacrylate or polycarbonate material. Lens 192 may also be any similar transparent material that is relatively strong and lightweight. In some embodiments, lens 192 has a thickness of about 0.125 inches. However, lens 192 may have a thickness that varies between about 0.05 inches and about 0.5 inches.

End cap 180 may include any material that inhibits foreign objects from entering housing 168. For example, end cap 180 may include steel, aluminum, or any similar metal or metal alloy. In an embodiment, end cap 180 is an aluminum plate. End cap 180 may also include PVC or any similar polymeric material. End cap 180 may have a thickness of about 0.125 inches, or, in some embodiments, a thickness between about 0.05 inches and about 0.5 inches. A thickness of end cap 180 may vary depending on a material used for the end cap and/or a desired strength of the end cap.

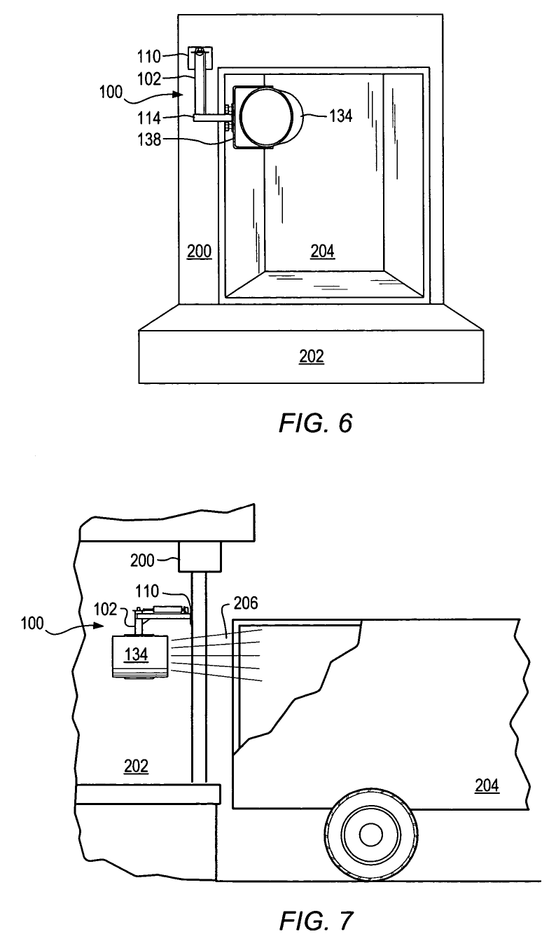

FIG. 6 depicts an embodiment of apparatus 100 mounted at a freight loading/unloading area from an end view of the freight loading/unloading area. FIG. 7 depicts an embodiment of apparatus 100 mounted at a freight loading/unloading area from a side view of the freight loading/unloading area. Apparatus 100 may be coupled to support structure 200 using mounting plate 110. In an embodiment, support structure 200 may be a wall of freight loading/unloading area 202. In some embodiments, support structure 200 may be a frame (e.g., a door frame) or a support beam. Trailer 204 may be located at freight loading/unloading area 202. Trailer 204 may be, for example, a truck or train trailer used for hauling freight. Light fixture 134 may be placed (e.g., affixed) in a set position to direct light into trailer 204. Light fixture 134 may provide light 206 into trailer 204 to assist in the loading/unloading of freight into/out of the trailer. In certain embodiments, a forklift or other freight moving device may be used to load/unload freight to/from trailer 104.

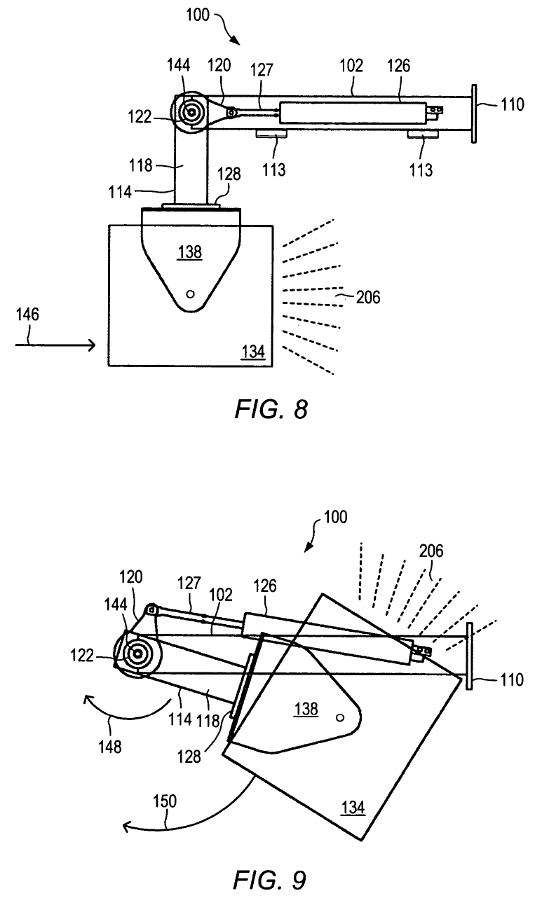

FIG. 8 depicts a top view of an embodiment of apparatus 100 with movable member 114 and light fixture 134 placed in a set position about an axis of mounting member 102. Movable member 114 and light fixture 134 may be placed in a set position about axis 144 of mounting member 102. Axis 144 may be a longitudinal axis of second portion 106 (depicted in FIGS. 1, 2A, and 2B) of mounting member 102. A set position of movable member 114 and light fixture 134 about axis 144 may be set by tightening bolt 122 as described herein. In the set position, light 206 from light fixture 134 may be directed into, for example, a trailer at a freight loading/unloading area (as shown in FIG. 4).

In an embodiment, light fixture 134 may be contacted by a moving object (e.g., a forklift) in a freight loading/unloading area. In some embodiments, light fixture 134 may be contacted by other objects (e.g., freight workers or hand trucks) in a freight loading/unloading area. If enough force is applied by a moving object to light fixture 134, the light fixture may be moved from its set position, shown in FIG. 8. For example, light fixture may be moved by an object moving in a direction shown by arrow 146 in FIG. 8. The force applied by the object moving in a direction of arrow 146 may cause light fixture 134 and movable member 114 to rotate about axis 144 into a position other than the set position, as shown in FIG. 9.

FIG. 9 depicts a top view of an embodiment of apparatus 100 with movable member 114 and light fixture 134 rotated from a set position about axis 144 of mounting member 102. As shown in FIG. 9, when movable member 114 and light fixture 134 are rotated from a set position, cam plate 120 is rotated and a force is applied to reciprocating member 126. Arm 127 of reciprocating member 126 may be extended by the force applied to the reciprocating member. Reciprocating member 126 may then provide a restoring force that retracts arm 127 and rotates cam plate 120 in a direction of arrow 148. Rotation of cam plate 120 may cause movable member 114 and light fixture 134 to rotate about axis 144, as shown by arrow 150, so that the movable member and the light fixture are restored or returned to a set position (e.g., the set position depicted in FIG. 8).

Thus, light fixture 134 is controllably returned to a set position by apparatus 100 without a user having to manually readjust the light fixture back to the set position (e.g., light fixture 134 is “automatically” returned to a set position by apparatus 100). Automatically and controllably returning light fixture 134 to a set position (e.g., an original position) may increase working efficiency (i.e., decrease the amount of time to load and/or unload freight) in a freight loading/unloading area because the freight loading/unloading area is substantially constantly illuminated. In certain embodiments, working efficiency may be increased by as much as about 33%. Working efficiency using apparatus 100 may also be increased by eliminating the time needed for manual readjustment of a light fixture to a set position after each collision with an object. In certain embodiments, the possibility of damage occurring to freight or other objects in a freight loading/unloading area may increase if a portion of the freight loading/unloading area is dark (e.g., not illuminated) for any significant period of time. Thus, maintaining substantially constant illumination of a freight loading/unloading area using apparatus 100 may reduce the possibility of damage occurring to freight or other objects in the freight loading/unloading area.

Impact forces imparted to light fixture 134 by objects (e.g., a forklift or freight on a forklift) during loading/unloading of freight may be reduced by allowing movable member 114 to move from a set position about an axis of mounting member 102. Reducing the forces imparted to light fixture 134 may decrease the possibility of damaging the light fixture (e.g., the light bulb) due to collisions with the light fixture. Allowing light fixture 134 and movable member 114 to move when impacted by objects (e.g., freight) on a forklift or other loading/unloading device may reduce damage to the objects by reducing the chances for the objects to fall off or be knocked off of the forklift.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. An apparatus for mounting a light fixture in a freight loading/unloading area, comprising:
a mounting member;
a restoring device coupled to the mounting member; and
a movable member coupled to the mounting member, wherein the movable member can at least partially rotate about an axis of the mounting member, wherein the movable member is configured to be coupled to a light fixture, and wherein the movable member is configured to be positioned in a set position about the axis of the mounting member to allow the light fixture to illuminate a freight loading/unloading area; and
wherein the restoring device is configured to provide a restoring force to return the movable member to approximately the set position if the movable member is moved from the set position.

2. (canceled)

3. (canceled)

4. The apparatus of claim 1, wherein the mounting member comprises a first portion and a second portion, and wherein the first portion is aligned at an angle to the second portion.

5. (canceled)

6. The apparatus of claim 4, wherein the movable member is coupled to the second portion of the mounting member.

7. (canceled)

8. (canceled)

9. The apparatus of claim 4, wherein the movable member can rotate about a longitudinal axis of the second portion of the mounting member.

10. The apparatus of claim 4, wherein a first end of the movable member is coupled to the second portion of the mounting member and a second end of the movable member is configured to be coupled to the light fixture so that the light fixture can rotate about a longitudinal axis of the second portion at a radius approximately equal to the length of the movable member, and wherein the rotation of the light fixture is not inhibited by any portion of the mounting member.

11. (canceled)

12. (canceled)

13. The apparatus of claim 1, wherein the movable member and the light fixture can rotate up to 360° about the axis of the mounting member prior to installation and up to 180° about the axis of the mounting member after installation.

14. The apparatus of claim 1, wherein the movable member can rotate in either direction about the axis of the mounting member.

15. (canceled)

16. The apparatus of claim 1, wherein the movable member is configured to move about the axis of the mounting member away from the set position when a force is applied to the movable member, and wherein the movable member is configured to move about the axis of the mounting member to return to the set position after movement due to the applied force.

17-21. (canceled)

22. The apparatus of claim 1, wherein the apparatus is configured to allow a user of the apparatus to align the light fixture by placing the movable member in the set position.

23-26. (canceled)

27. An apparatus for mounting a light fixture in a freight loading/unloading area, comprising:
a mounting member;
a reciprocating member pivotally coupled to the mounting member;
a cam device coupled to the reciprocating member and the mounting member; and
a movable member coupled to the mounting member, wherein the movable member can at least partially rotate about an axis of the mounting member, wherein the movable member is configured to be coupled to a light fixture, and wherein the movable member is configured to be positioned in a set position about the axis of the mounting member to allow the light fixture to illuminate a freight loading/unloading area; and
wherein the cam device and the reciprocating member are configured to provide a restoring force to return the movable member to approximately the set position if the movable member is moved from the set position.

28. The apparatus of claim 27, wherein the mounting member comprises a first portion and a second portion, and wherein the first portion is aligned at an angle to the second portion.

29. (canceled)

30. (canceled)

31. The apparatus of claim 28, wherein the movable member is coupled to the second portion of the mounting member.

32-34. (canceled)

35. The apparatus of claim 28, wherein a first end of the movable member is coupled to the second portion of the mounting member and a second end of the movable member is configured to be coupled to the light fixture so that the light fixture is offset from the second portion of the mounting member a distance approximately equal to the length of the movable member.

36-38. (canceled)

39. The apparatus of claim 27, wherein the movable member is configured to move about the axis of the mounting member when a force is applied to the movable member.

40. The apparatus of claim 27, wherein the movable member is configured to move about the axis of the mounting member away from the set position when a force is applied to the movable member, and wherein the movable member is configured to move about the axis of the mounting member to return to the set position after movement due to the applied force.

41-43. (canceled)

44. The apparatus of claim 27, wherein the movable member is configured to allow the light fixture to be tilted relative to the movable member to allow the light fixture to direct light to the freight loading/unloading area.

45-50. (canceled)

51. An assembly for illuminating a freight loading/unloading area, comprising:
a mounting member;
a reciprocating member pivotally coupled to the mounting member;
a cam device coupled to the reciprocating member and the mounting member;
a movable member coupled to the mounting member, wherein the movable member can at least partially rotate about an axis of the mounting member, and wherein the movable member is configured to be positioned in a set position about the axis of the mounting member; and
a light fixture coupled to the movable member such that the light fixture is configured to illuminate a freight loading/unloading area when the movable member is in the set position;
wherein the cam device and the reciprocating member are configured to provide a restoring force to return the movable member to approximately the set position if the movable member is moved from the set position.

52. The assembly of claim 51, wherein the mounting member comprises a first portion and a second portion, and wherein the first portion is aligned at an angle to the second portion.

53. The assembly of claim 52, wherein the first portion is aligned at an angle between about 70° and about 110° to the second portion.

54. (canceled)

55. (canceled)

56. The assembly of claim 52, wherein the movable member is coupled to the second portion of the mounting member, and wherein the first portion of the mounting member is configured to be coupled to a supporting structure.

57. The assembly of claim 52, wherein the movable member can rotate about a longitudinal axis of the second portion of the mounting member.

58. (canceled)

59. (canceled)

60. The assembly of claim 52, wherein a length of the second portion of the mounting member is selected to locate a plane of the light fixture a desired distance lower than a plane of the first portion of the mounting member so that the light fixture can rotate 360° about a longitudinal axis of the second portion.

61-63. (canceled)

64. The assembly of claim 51, wherein the movable member is configured to move about the axis of the mounting member away from the set position when a force is applied to the movable member, and wherein the movable member is configured to move about the axis of the mounting member to return to the set position after movement due to the applied force.

65. (canceled)

66. (canceled)

67. The assembly of claim 51, wherein the movable member is coupled to the mounting member so that movement of the light fixture coupled to the movable member is not inhibited by the mounting member.

68. The assembly of claim 51, wherein the light fixture is coupled to the movable member such that the light fixture directs light to the freight loading/unloading area when the movable member is in the set position.

69. (canceled)

70. The assembly of claim 51, wherein the light fixture is configured to light an interior of a freight truck located adjacent to the freight loading/unloading area during use.

71-75. (canceled)
